(19) United States
(12) Patent Application Publication
(10) Pub. No.: US 2005/0082018 A1
(43) Pub. Date: Apr. 21, 2005

(54) Cord fixing device for a non cord operated venetian blind

(76) Inventor: Leslie Nien, Changhua Hsien (TW)

Correspondence Address: TROXELL LAW OFFICE PLLC;SUITE 1404, 5205 LEESBURG PIKE, FALLS CHURCH, VA, 22041, US

(21) Appl. No.: 10/778,397

(22) Filed: Feb. 17, 2004

(30) Foreign Application Priority Data
Oct. 17, 2003 (TW) 092218495

(51) Int. Cl. E06B 9/30

(52) U.S. Cl. 160/172 R

(57) ABSTRACT

A cord fixing device for a non cord operated Venetian blind includes a blind embodiment, two mounting seats, and two fastening strips wherein a retaining cord led through each lateral sides of the blind embodiment respectively is provided with a ring element fixedly attached to the bottom end thereto. The mounting seat has an inverted U-shaped support piece protruding at the central top surface thereon with a hook hole formed at the interior therein, and a plurality of through holes disposed at the four corners thereon. The fastening strip is equipped with a male and a female Velcro component at the opposite lateral sides thereon respectively for mutual fastening thereby. When the mounting seat is securely fixed to each lateral side of a windowsill, the fastening strip thereof is joined into an annular shape via the male/female Velcro components and hooked at the ring element of the retaining cord and the support piece of the mounting seat there-between, properly stretching tight and straight the retaining cord thereof. In case the retaining cord is pulled by great force from outside, the mutually engaged male/female Velcro components thereof will be detached to release the fastening strip, preventing children from getting hurt or strangled by the retaining cord thereof when curiously putting their heads into the space between the retaining cord and the windowsill thereof so as to efficiently protect the safety of the family.

### BACKGROUND OF THE INVENTION

The present invention is related to a cord fixing device for a non cord operated Venetian blind, comprising a blind embodiment, two mounting seats, and two fastening strips wherein a ring element is fixedly attached to the bottom end of a retaining cord disposed at each lateral side of the blind embodiment thereof. The mounting seat has an inverted U-shaped support piece protruding at the central top surface thereon with a hook hole formed at the interior therein, and the fastening strip is equipped with a male and a female Velcro components disposed at the opposite lateral sides thereon respectively; whereby, the fastening strip thereof is joined into an annular shape at both ends via the male/female Velcro components and hooked at the ring element of the retaining cord and the support piece of the mounting seat there-between, properly stretching downwards the retaining cord thereof. In case the retaining cord is pulled by great force from outside, the mutually engaged male/female Velcro components thereof will be detached to release the fastening strip, preventing children from getting hurt by the retaining cord thereof when curiously putting their heads into the space between the retaining cord and a windowsill thereof so as to efficiently protect the safety of the family.

Please refer to FIG. 1. A conventional non-pull cord Venetian blind is made up of a blind embodiment 10 attached to the underside of an upper beam 11, and a retaining cord 12 led through both lateral sides of the blind embodiment 10 thereof respectively before passed through a pivot hole (not shown in the diagram) disposed at each lateral end of a lower beam 13 to be straightly stretched downwards and tied up to a windowsill A at the bottom end thereof. Via clamping devices (not shown in the diagram) adapted at both ends of the lower beam 13 therein, the blind embodiment 10 is adjusted upwards or downwards along the retaining cord 12 in the withdrawing or unfolding operation thereof.

There are some drawbacks to such conventional non-pull cord Venetian blind. Most of all, the retaining cord 12 thereof is fixedly tied up to the windowsill A thereon, which, in case pulled by great force from outside, can be turned into a hard and dangerous cutting string like a fishing line and easily hurt children when they curiously put their heads into the space between the retaining cord 12 and the windowsill A thereof. Thus, the conventional non-pull cord Venetian blind unsafely poses a potential danger to people in the household.

### SUMMARY OF THE PRESENT INVENTION

It is, therefore, the primary purpose of the present invention to provide a cord fixing device for a non cord operated Venetian blind, comprising a blind embodiment, two mounting seats, and two fastening strips wherein a ring element is fixedly attached to the bottom end of a retaining cord disposed at each lateral side of the blind embodiment thereof; whereby, each fastening strip joined into an annular shape via male/female Velcro components disposed at the opposite lateral sides thereon is hooked at the ring element of the retaining cord and an inverted U-shaped support piece of the mounting seat there-between, properly stretching downwards the retaining cord thereof. In case the retaining cord is pulled by great force from outside, the mutually engaged male/female Velcro components thereof will be detached to release the fastening strip, preventing children from getting hurt or strangled by the retaining cord thereof when curiously putting their heads into the space between the retaining cord and a windowsill so as to efficiently protect the safety of the family.

It is, therefore, the secondary purpose of the present invention to provide a cord fixing device for a non cord operated Venetian blind wherein, via the male/female Velcro components of each fastening strip mutually engaged in an easy and fast manner, the retaining cord is properly adjusted in tightness to achieve the best using condition thereof.

### BRIEF DESCRIPTION OF THE DRAWINGS

FIG. 1 is a plan view of a conventional non-pull cord Venetian blind in assembly.

FIG. 2 is a perspective exploded view of a mounting seat of the present invention.

FIG. 3 is a plane view of the present invention in assembly.

FIG. 4 is a partially enlarged view of the present invention in assembly.

FIG. 5 is a partially enlarged view of another embodiment of the present invention.

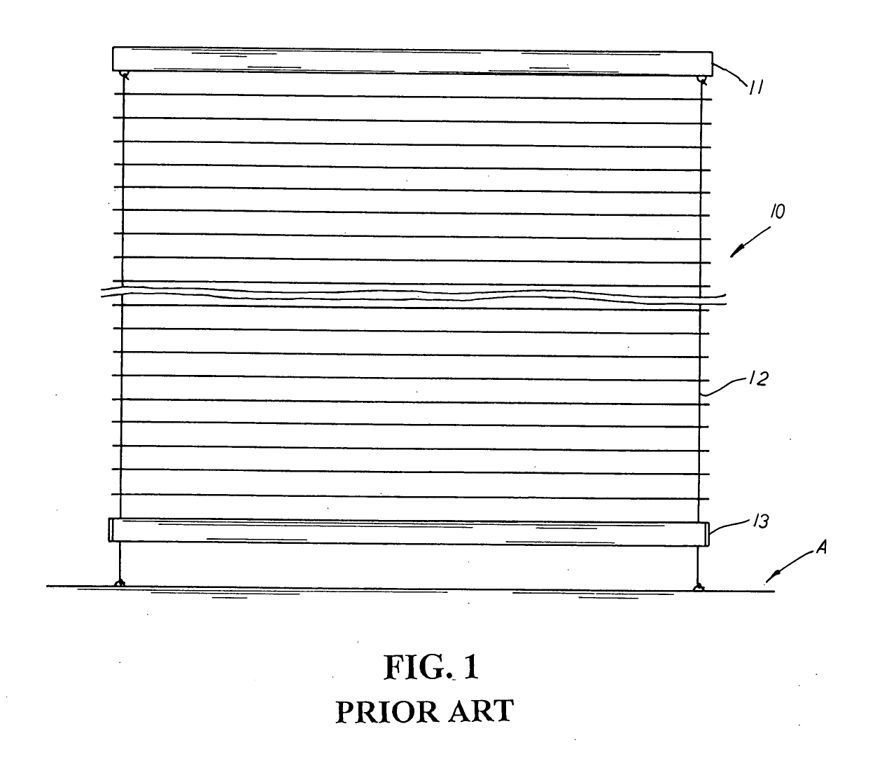

### DETAILED DESCRIPTION OF THE PREFERRED EMBODIMENTS

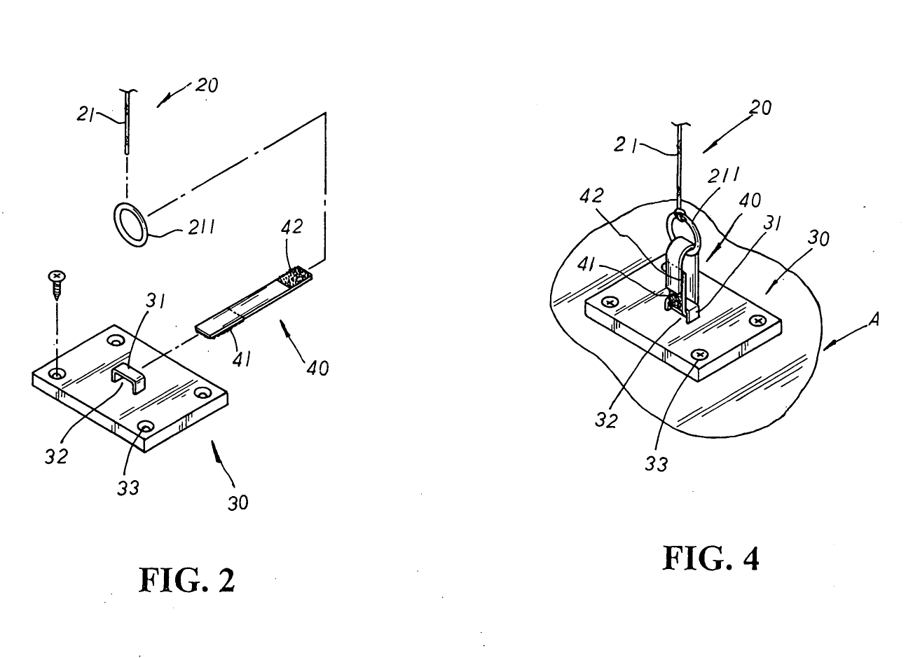

Please refer to FIG. 2. The present invention is related to a cord fixing device for a non cord operated Venetian blind, comprising a blind embodiment 20, two mounting seats 30, and two fastening strips 40. A retaining cord 21 is led through both lateral sides of the blind embodiment 20 respectively and passed through each lateral end of a lower beam 22 with a ring element 211 securely fixed at the bottom end thereon. The mounting seat 30 has an inverted U-shaped support piece 31 protruding at the central top surface thereon, a hook hole 32 defined at the interior of the inverted U-shaped support piece 31 therein, and a plurality of through holes 33 disposed at the four corners thereon. The fastening strip 40 is provided with a male and a female Velcro component 41, 42 disposed at the opposite surface of both lateral sides thereon respectively for mutual fastening thereby.

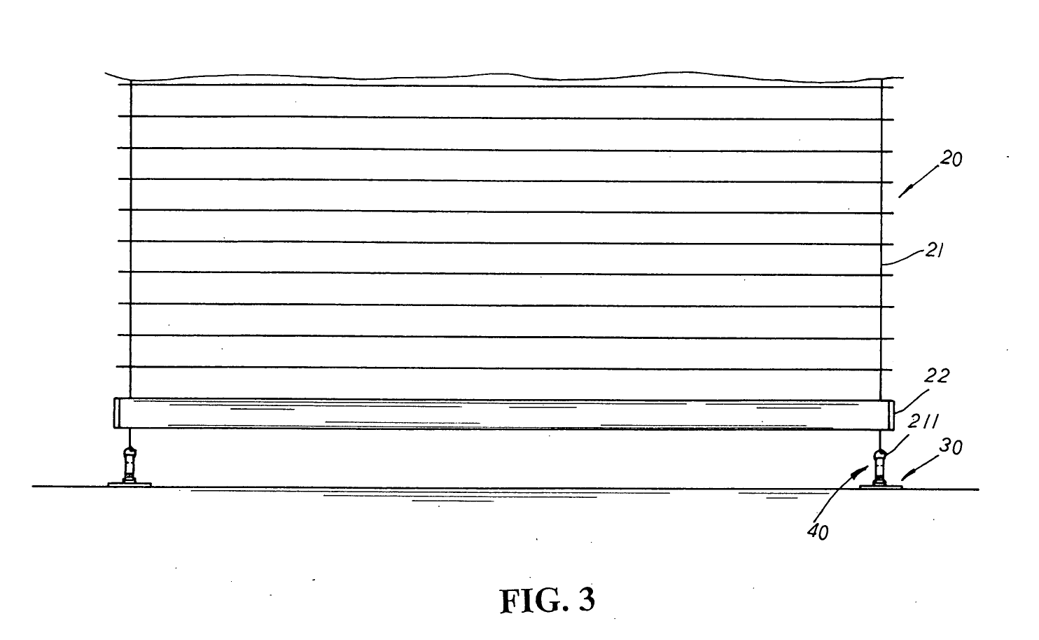

Please refer to FIGS. 3 to 4 inclusive. In assembly, the through holes 33 of the two mounting seats 30 are joined to the upper surface of a windowsill A via screws to securely fix the two mounting seats 30 at both lateral side of the windowsill A respectively. Both ends of the fastening strip 40 are applied to wind through the ring element 211 of the retaining cord 21 and the hook hole 32 of the mounting seat 30 respectively before mutually closed up and adjustably fastened into an annular shape via the male and female Velcro components 41, 42 thereof. Thus, the fastening strip 40 is securely hooked at the retaining cord 21 and the inverted U-shaped support piece 31 there-between, properly stretching tight and straight the retaining cord 21 thereof. In case the retaining cord 21 is pulled by great force from outside, the mutually engaged male/female Velcro components 41, 42 thereof will be detached to release the fastening strip 40 from the ring element 211 and the hook hole 32 thereof, preventing children from getting hurt or strangled by the retaining cord 21 thereof when curiously putting their heads into the space formed by the retaining cord 21 and the windowsill A thereof so as to efficiently protect the safety of the family.

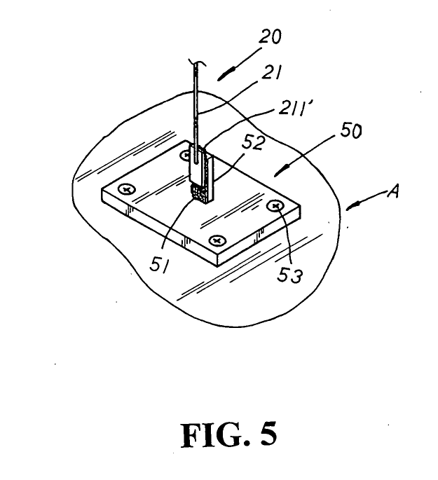

Please refer to FIG. 5. A male Velcro piece 211′ can also be fixedly sewed to the bottom end of the retaining cord 21 of the blind embodiment 20 thereof to be adjustably fastened to a female Velcro piece 51 of a fixing seat 50 thereby. The fixing seat 50 thereof is equipped with a vertical support plate 52 protruding upwards at the central top surface thereon for the female Velcro piece 51 to be securely attached thereto, and a number of fixing holes 53 disposed at the four corners thereon to locate the fixing seat 50 onto each lateral upper surface of the windowsill A thereby.

1. A cord fixing device for a non cord operated Venetian blind, comprising a blind embodiment, two mounting seats, and two fastening strips wherein a retaining cord is led through both lateral sides of the blind embodiment respectively and passed through each lateral end of a lower beam; the present invention being characterized by that,
a ring element being fixedly attached to the bottom end of the retaining cord thereof;
the mounting seat having an inverted U-shaped support piece protruding at the central top surface thereon, a hook hole formed at the interior of the inverted U-shaped support piece therein, and a plurality of through holes disposed at the four corners thereon;
the fastening strip being provided with a male and a female Velcro components disposed at the opposite surface of both lateral sides thereon respectively for mutual fastening thereby;
in assembly, when the mounting seat is securely fixed to the upper surface of each lateral side of a windowsill, both ends of the fastening strip led through the ring element and the hook hole of the inverted U-shaped supported piece thereof respectively are mutually fastened into an annular shape via the male and female Velcro components thereof to hook the fastening strip thereof at the retaining cord and the inverted U-shaped support piece there-between, properly stretching tight and straight the retaining cord thereof; thus, in case the retaining cord is pulled by great force from outside, the male/female Velcro components thereof will be mutually detached to release the fastening strip from the ring element and the hook hole thereof, preventing children from getting hurt or strangled by the retaining cord thereof when curiously putting their heads into the space formed by the retaining cord and the windowsill thereof so as to efficiently protect the safety of the family.

2. The cord fixing device for a non cord operated Venetian blind as claimed in claim 1 wherein a male Velcro piece can also be fixedly sewed to the bottom end of the retaining cord thereof to be adjustably fastened to a female Velcro piece of a fixing seat that is equipped with a vertical support plate protruding upwards at the central top surface thereon for the female Velcro component to be securely attached thereto, and a number of fixing holes disposed at the four corners thereon to locate the fixing seat onto each lateral upper surface of the windowsill thereby.
